(19) United States
(12) Patent Application Publication
(10) Pub. No.: US 2016/0318738 A1
(43) Pub. Date: Nov. 3, 2016

(54) METHOD FOR HANDLING AND MODERNIZING ROPES IN AN ELEVATOR AND ARRANGEMENT FOR DISMANTLING ROPES OF AN ELEVATOR

(71) Applicants: Pentti Alasentie, Espoo (FI); Jarmo Reijonen, Hyvinkaa (FI); Sakari Korvenranta, Hyvinkaa (FI)

(72) Inventors: Pentti Alasentie, Espoo (FI); Jarmo Reijonen, Hyvinkaa (FI); Sakari Korvenranta, Hyvinkaa (FI)

(73) Assignee: Kone Corporation, Helsinki (FI)

(21) Appl. No.: 15/092,900

(22) Filed: Apr. 7, 2016

(30) Foreign Application Priority Data
Apr. 30, 2015 (FI) 20155321

(51) Int. Cl. B66B 19/02; B66B 7/06

(52) U.S. Cl. CPC B66B 19/02; B66B 7/062

(57) ABSTRACT

The invention relates to a method for handling and modernizing ropes in an elevator, which elevator comprises at least an elevator car arranged to run in an elevator shaft along the guide rails, a counterweight connected to the elevator car with hoisting ropes from above, a hoisting machinery with a traction sheave above the elevator car, and compensating ropes connected between the elevator car and the counterweight through a compensating mechanism at a lower part of the elevator shaft. The old hoisting ropes and compensating ropes are dismantled when the elevator car has been run to the upper part of the elevator shaft without a risk of losing the friction on the traction sheave.

This application claims priority to Finnish Patent Application No. 20155321 filed on Apr. 30, 2015, the entire contents of which are incorporated herein by reference.

The present invention relates to a method as defined in the preamble of claim 1 for handling ropes in an elevator and a method as defined in the preamble of claim 9 for modernizing in an elevator, and an arrangement as defined in the preamble of claim 17 for dismantling compensating ropes and/or hoisting ropes of an elevator.

In tall buildings elevator hoisting ropes consisting of a set of parallel similar steel ropes are long and substantially thick and for that reason they are usually very heavy. In addition in tall buildings also compensating ropes are needed to compensate the weight of the hoisting ropes. The first ends of the compensating ropes are usually fastened under the elevator car, either directly into a car of into a frame-like car sling that supports the car. From the car the compensating ropes are led downwards towards the bottom of the elevator shaft where they go around one or more deflection sheaves and then the second ends of the compensating ropes are fastened into the counterweight. In tall buildings the compensating ropes form usually a set of parallel ropes where a number of similar ropes can be for instance two or more. It is clear that this kind of set consisting of several long and substantially thick ropes is also very heavy.

The problem in prior art is the handling of the sets of the hoisting ropes and compensating ropes during installation and dismantling. Especially when changing old ropes to new ropes the dismantling of the sets of ropes is very laborious, time consuming and can also be dangerous. One risk factor is the dismantling of the compensating ropes. If the compensating ropes are unfastened in a wrong way there is a great risk to lose friction on the traction sheave in which case the whole elevator system falls into an unbalanced situation.

One object of the present invention is to eliminate drawbacks of prior art technology and to achieve an advantageous, fast, easy and safe method for handling ropes in an elevator especially when dismantling compensating ropes and hoisting ropes in tall high-rise buildings, either for dismantling, chancing of modernization purposes. The method according to the invention for handling ropes in an elevator is characterized by what is presented in the characterization part of claim 1, and the method according to the invention for modernizing ropes in an elevator is characterized by what is presented in the characterization part of claim 9, and the arrangement for dismantling compensating ropes and/or hoisting ropes of an elevator is characterized by what is presented in the characterization part of claim 17. Other embodiments of the invention are characterized by what is presented in the other claims.

The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can, in at least some situations, be deemed to be inventive in their own right.

Also the terms used must be understood in their broad meaning. For instance, the terms disconnect and unfasten used in connection with ropes may both mean the same, for instance, an act of separating ropes from they fastening points, by loosing a fixing or cutting the ropes.

The method according to the invention has several useful advantages. Among other things it makes it possible to unfasten the compensating ropes safer and faster than in prior art systems without a fear to lose friction on the traction sheave in any phase. Another advantage is that it makes it easier to modernize the elevator for instance by changing thick and heavy steel ropes to much lighter and more durable thin hoisting elements that are made of much durable material than steel. For instance, a flat belt comprising a carbon fiber core and a high-friction coating can be used instead of heavy metal ropes. This gives additional advantages. For example elevator energy consumption in high-rise buildings can be cut significantly because the moving masses of the elevator drop significantly thanks to the much lighter ropes. And the higher the building the more weight can be removed, and therefore the more energy can be saved.

A particular advantage of using the invention is improved safety during dismantling the old compensation rope/ropes of an elevator.

An advantage of using the invention is improved efficiency particularly when dismantling the old compensation rope/ropes of an elevator.

In the following, the invention will be described in detail by the aid of example embodiments by referring to the attached simplified and diagrammatic drawings, wherein

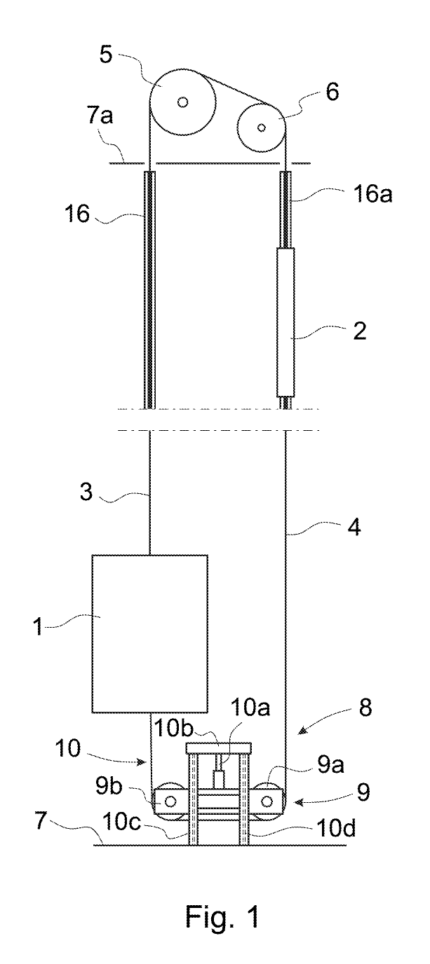

FIG. 1 presents in a simplified and diagrammatic side view, and cut in a vertical direction, a high-rise building elevator arrangement where the method according to the invention can be used,

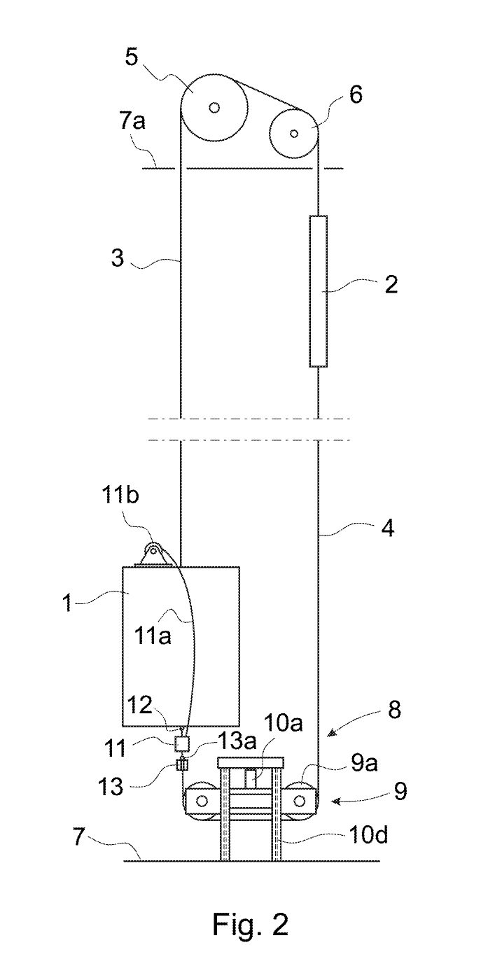

FIG. 2 presents in a simplified and diagrammatic side view the first main step of the method according to the invention in an elevator arrangement of FIG. 1,

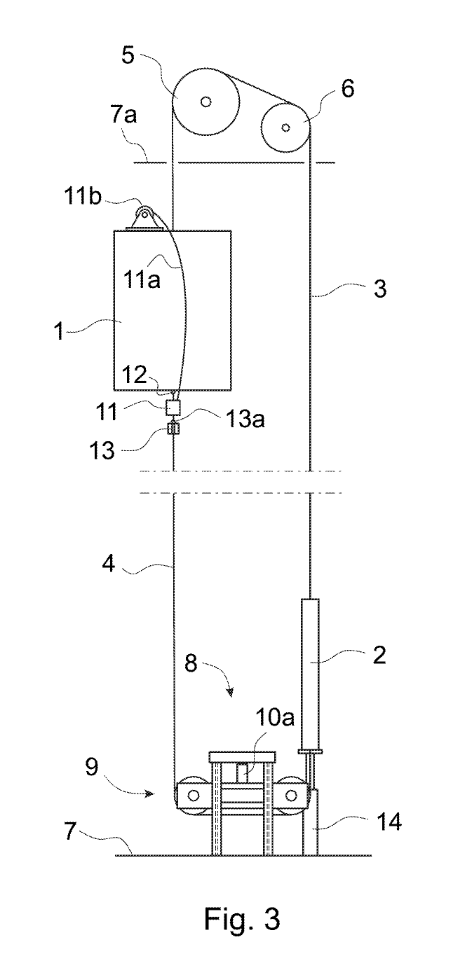

FIG. 3 presents in a simplified and diagrammatic side view the second main step of the method according to the invention in an elevator arrangement of FIG. 1,

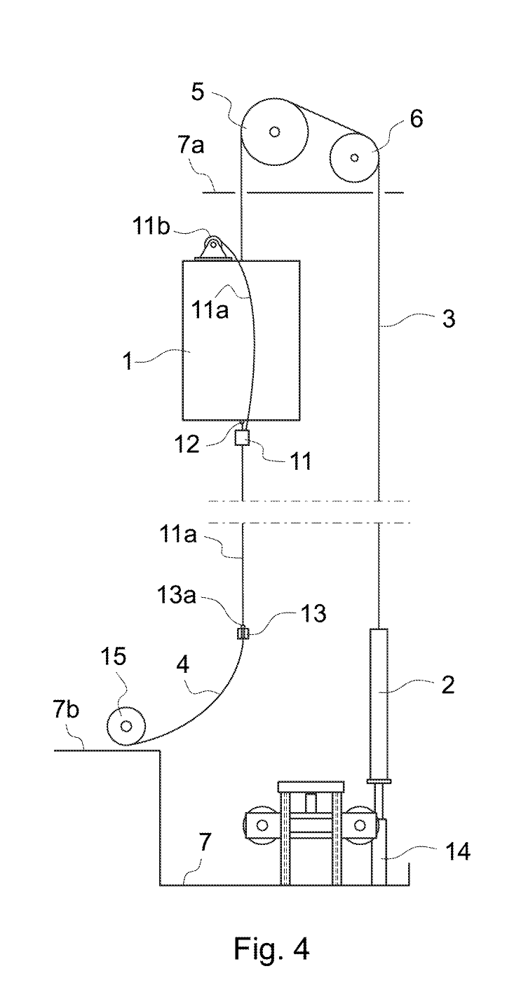

FIG. 4 presents in a simplified and diagrammatic side view the third main step of the method according to the invention in an elevator arrangement of FIG. 1,

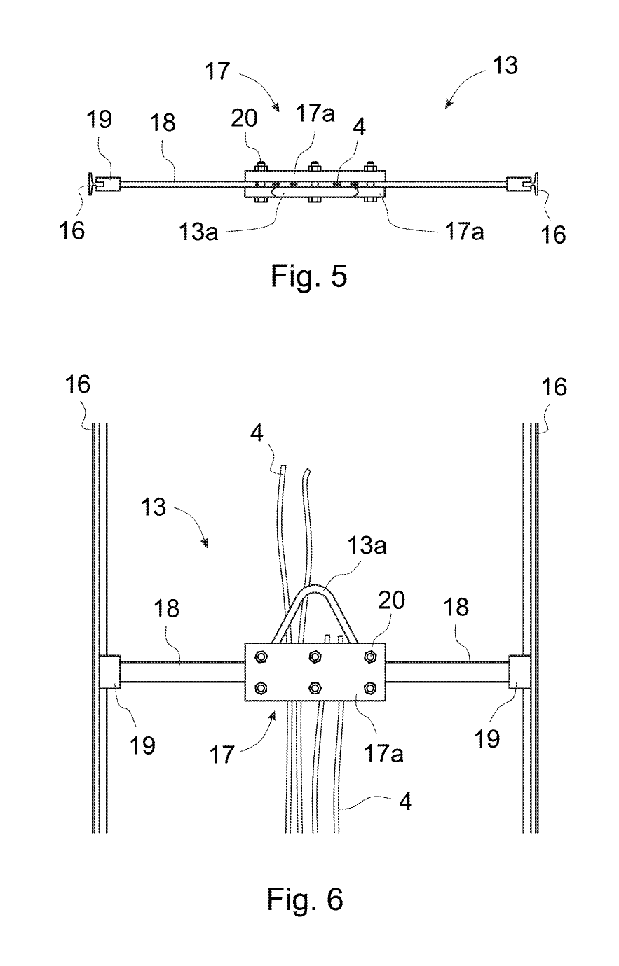

FIG. 5 presents in a simplified and diagrammatic top view a roping tool according to the invention mounted onto the guide rails of the elevator car,

FIG. 6 presents in a simplified and diagrammatic side view the roping tool according to the invention mounted onto the guide rails of the elevator car,

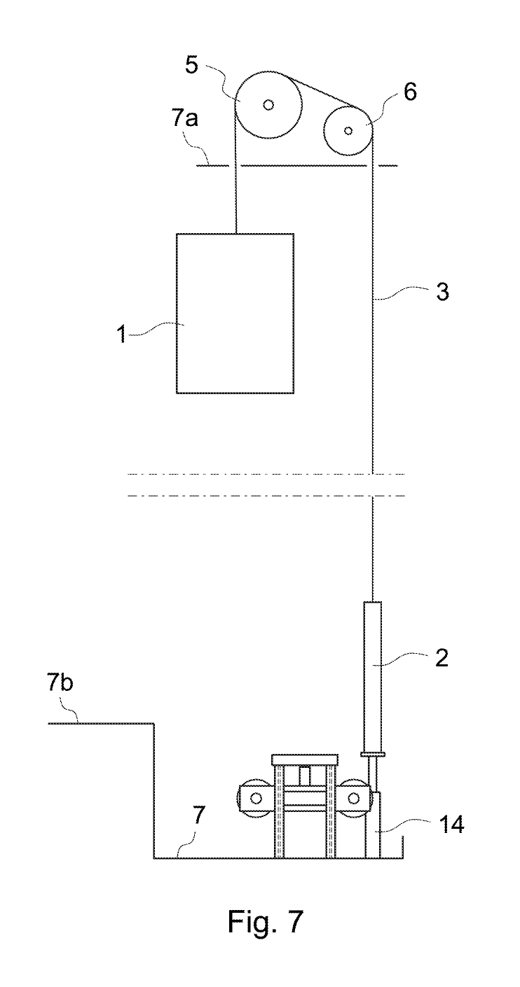

FIG. 7 presents in a simplified and diagrammatic side view, and cut in a vertical direction, a high-rise building elevator arrangement ready for dismantling the hoisting ropes,

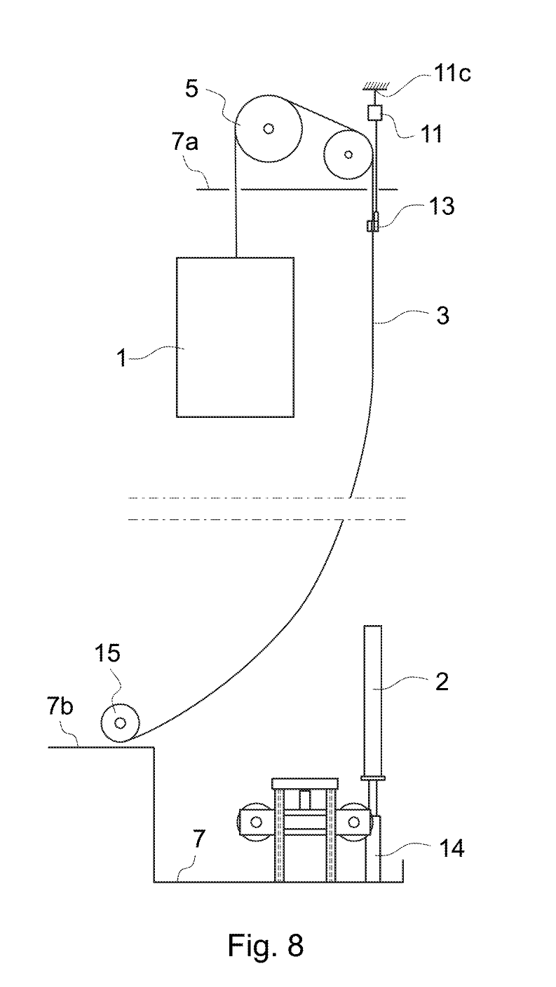

FIG. 8 presents in a simplified and diagrammatic side view, and cut in a vertical direction, a high-rise building elevator arrangement where the dismantling of the hoisting ropes has just started,

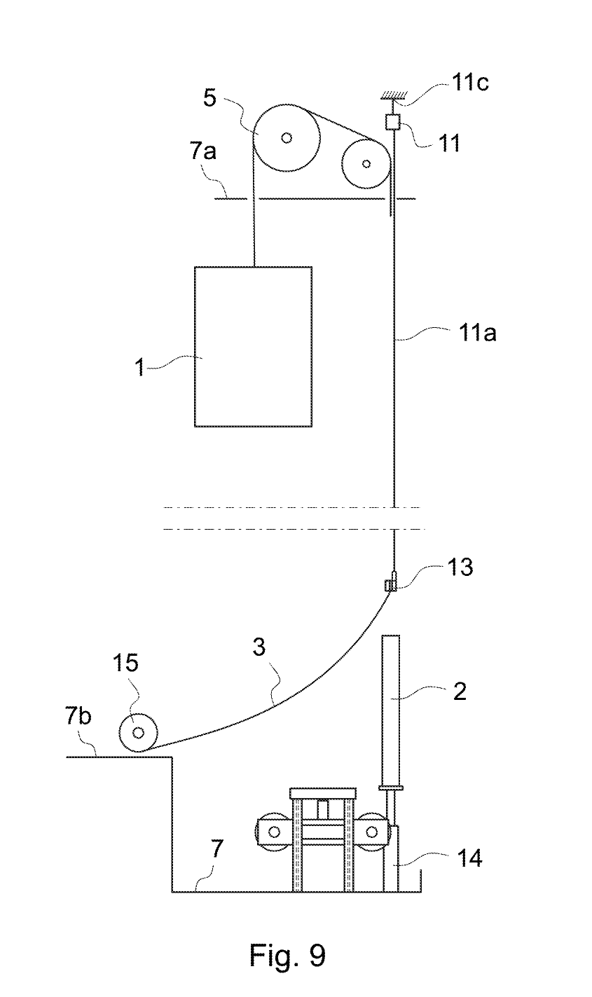

FIG. 9 presents in a simplified and diagrammatic side view, and cut in a vertical direction, a high-rise building elevator arrangement where the dismantling of the hoisting ropes has proceeded further, and

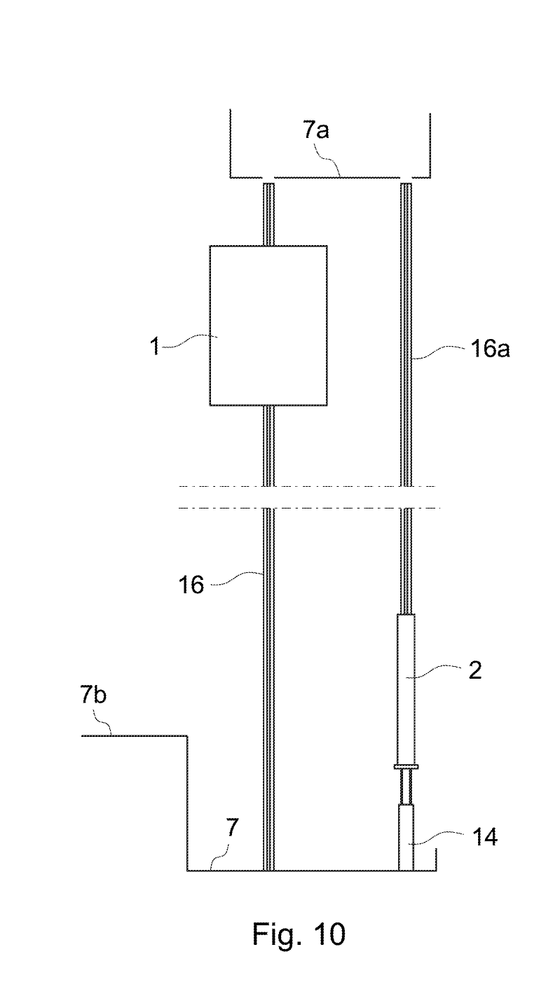

FIG. 10 presents in a simplified and diagrammatic side view, and cut in a vertical direction, a high-rise building elevator arrangement where the dismantling of the hoisting ropes has been completed and the elevator is ready for new ropes.

FIG. 1 presents in a simplified and diagrammatic side view a typical elevator roping arrangement used in tall high-rise buildings. For the sake of clarity only the upper end and lower end of the elevator arrangement in an elevator shaft is presented. A typical elevator arrangement comprises an elevator car 1 and a counterweight 2 that go up and down guided by their guide rails 16, 16a. For the sake of clarity the elevator car guide rail 16 and the counterweight guide rail 16a are shown only in FIGS. 1 and 10 in one side of the car and counterweight, and further in FIG. 1 the guide rails 16, 16a are shown only at the upper part of the elevator shaft. The elevator car 1 and the counterweight 2 are connected together with a bundle of parallel hoisting ropes 3 whose first ends are fastened into the elevator car 1, either directly into a car 1 or into a frame-like sling that supports the car 1. For the sake of clarity the sling is presented neither in FIG. 1 nor in the other figures. The hoisting ropes 3 are led from the elevator car 1 to the counterweight 2 around a traction sheave 5 and if needed also around a deflection sheave 6 which both are situated either at top part of the elevator shaft or in a machine room above the elevator shaft. In this embodiment the traction sheave 5 and the deflection sheave 6 are placed in the machine room above the elevator shaft and the hoisting ropes 3 go through holes in the floor 7a of the machine room.

As mentioned earlier the long and for that reason heavy steel ropes causes balancing problems in high-rise buildings. For that reason compensating ropes 4 are usually needed in high-rise elevator arrangements. The compensating ropes 4 also comprise a bundle of heavy parallel steel ropes that are fastened between the elevator car 1 and counterweight 2 so that the first ends of the compensating ropes 4 are fastened into the lower part of the elevator car 1, either directly into a car 1 or into a frame-like sling. From the car 1 the compensating ropes 4 are led to the counterweight 2 around a deflection sheave arrangement 9 comprising usually one or two deflection sheaves 9a per each compensating rope 4, and from the deflection sheave arrangement 9 the compensating ropes 4 are led to the counterweight 2 where the second ends of the compensating ropes 4 are fastened.

The deflection sheave arrangement 9 is a part of a compensating mechanism 8 that is situated on the bottom 7 of the elevator shaft. In this embodiment the deflection sheave arrangement 9 comprises two sets of deflection sheaves 9a, each set on its own shaft that is fastened into a frame 9b of the deflection sheave arrangement 9. In that case the deflection sheaves 9a are bearing-mounted on their own shafts. The structure can also be such that the shafts of the deflection sheaves 9a are bearing-mounted on the frame 9b of the deflection sheave arrangement 9.

The compensating mechanism 8 also includes a tensioning mechanism 10 to keep the tension of the compensating ropes 4 within allowed limits. The tensioning mechanism 10 includes vertical support beams 10c that has vertical guide rails 10d to guide vertical movements of the deflection sheave arrangement 9, and a tensioning device 10a that can be a hydraulic cylinder or a set of additional weights. In this embodiment the tensioning device 10a is a hydraulic cylinder that is fastened between the frame 9b of the deflection sheave arrangement 9 and a fixed point formed by a top beam 10b of the compensating mechanism 8. The deflection sheave arrangement 9 can basically move up and down on the guide rails 10d but usually the tensioning device 10a pushes the deflection sheave arrangement 9 downwards so that a sufficient tension remains in the compensating ropes 4.

FIG. 2 presents in a simplified and diagrammatic side view a part of the first main step of the method according to the invention in an elevator arrangement like shown in FIG. 1. The method in this phase concerns the dismantling of the compensating ropes 4 in an elevator in a high-rise building.

In the method the first main step is to run the elevator car 1 down to a lower part of the elevator shaft close to the lowermost landing floor 7b to such a position where a roping tool 13 can be mounted easily on the elevator car rails 16 below the elevator car 1 and above the compensating mechanism 8, and where an auxiliary hoist 11, such as a Tirak hoist or a corresponding hoist can be installed between the roping tool 13 and the elevator car 1. When the elevator car 1 is in its correct position in a lower part of the elevator shaft either on the lowermost landing floor 7b or close to it the deflection sheave arrangement 9 of the compensating mechanism 8 are lifted upwards, for instance to its uppermost position and locked there to get the compensating ropes 4 loose enough. The lifting reduces tension in the compensating mechanism 8. After that the first ends of the compensating ropes 4 are unfastened from their fastening points in the elevator car 1. The next step is to mount the roping tool 13 onto the elevator car guide rails 16 and fasten the unfastened ends of the compensating ropes 4 to the roping tool 13. If the end parts of the compensating ropes 4 above the roping tool 13 remain too long the extra length is cut away.

In the next step the auxiliary hoist 11, such as a Tirak hoist or a corresponding hoist is installed between the roping tool 13 and the elevator car 1 so that the hoist 11 is suspended from the elevator car 1 or from the car sling from its point of suspension 12 and the roping tool 13 is suspended by the auxiliary hoist 11 through its suspension hook 13a. In order to make this possible an auxiliary hoisting rope reel 11b and cables for the auxiliary hoist 11 are installed in their position on the roof of the car 1 and the auxiliary hoisting rope 11a is guided from the reel 11b through the auxiliary hoist 11 to the suspension hook 13a of the roping tool 13. After that the compensating ropes 4 are tightened with the auxiliary hoist 11 to prevent loose ropes during the upward run of the elevator car 1.

FIG. 3 presents in a simplified and diagrammatic side view a part of the second main step of the method according to the invention. In this phase the elevator car 1 with the auxiliary hoist 11 is run to the top part of the elevator shaft. The run is done as a service run or other slow motion safety run from the control panel of the elevator. The run lifts the auxiliary hoist 11, the roping tool 13 and the unfastened ends of the compensating ropes 4 at the same time as high as possible and the counterweight 2 descents to its lowermost position close to the compensating mechanism 8, so that the second ends of the compensating ropes 4 are attainable from the bottom 7 of the elevator shaft.

At this stage the next step is to install suitable support elements 14 under the counterweight 2 at a predetermined height, and to run the counterweight 2 onto the support elements 14. After that the counterweight 2 cannot go further down.

The next step is to arrange empty rope reels 15 on the lowermost landing floor 7b. A part of this step is shown in FIG. 4 where the reels 15 are shown in a simplified way. After that the second ends of the compensating ropes 4 are released from the counterweight 2 and routed to the empty reels 15 where they are fastened to the reels 15. The releasing can be done either by cutting the compensating ropes 4 near their second ends or unfastening the second ends from their fastening points. During this phase the elevator car 1 is also parked and/or locked in its position, for example, with the help of the safety gears of the elevator. Also separate clamps on the guide rails 16 can be used. In addition the elevator car 1 can be secured with separate safety chains. Now the next step is possible and the roping tool 13 with the first ends of the bundle of compensating ropes 4 is lowered down by the help of the auxiliary hoist 11 and the compensating ropes 4 starting with their unfastened second ends are simultaneously guided to the rope reels 15. After that the final steps are unfastening the first ends of the compensating ropes 4 from the roping tool 13, removing the roping tool 13 from the elevator car rails 16 and finally removing the reels 11b and 15 and the auxiliary hoist 11.

One embodiment of the roping tool 13 suitable for the method described above is presented in FIGS. 5 and 6. In FIG. 5 the roping tool 13 is seen on elevator guide rails 16 in a top view and the in FIG. 6 the roping tool 13 is seen on the elevator guide rails 16 in a side view. The roping tool 13 comprises, for instance, a two-piece frame 17, two arms 18 extending sideways to opposite directions from the frame 17, two slide blocks 19 that are installed on the elevator guide rails 16 to slide up and down along the guide rails 16, and of a suspension hook 13a. The first ends of the arms 18 are fastened to the frame 17 and the slide blocks 19 are fastened to the second ends of the arms 18. The frame 17 comprises two parallel plates 17a that can be tightened against each other with a set of tightening bolts and nuts 20. When using the roping tool 13 the unfastened ends of the compensating ropes 4 are placed between the plates 17a and the plates 17a are tightened against each other so that the ropes 4 are pressed between the plates 17a so tightly that the roping tool 13 can carry the total mass of the compensating ropes 4. The same roping tool 13, suitably adapted, can also be used on counterweight rails 16a when dismantling hoisting ropes 3 of the elevator.

The method according to the invention makes it possible to remove the compensating ropes 4 without a risk of losing friction on the traction sheave 5. During the dismantling process the balance in the elevator arrangement remains constant and there is no need to improve the friction by loading the elevator car 1 or unloading the counterweight 2.

The method according to the invention described above can advantageously be a part of a modernization process where old and heavy steel ropes are changed to much lighter roping elements such as flat belts comprising a carbon fiber core and a unique high-friction coating. In that case the first phase of the method for dismantling the compensating ropes 4 is similar to the method described above. After the final steps of dismantling the compensating ropes 4 the next phase now is dismantling of the old hoisting ropes 3. FIGS. 7-10 describe that phase.

Thus, the next step now is to arrange a new set of empty rope reels 15 for the hoisting ropes 3 to be dismantled on the lowermost landing floor 7b. After that, in the next step, the second ends of the hoisting ropes 3 are unfastened from the counterweight 2. And in the next step a roping tool 13, either the same used when dismantling the compensating ropes 4 or a different one, is mounted onto the guide rails 16a of the counterweight 2. The mounting is done from the roof of the elevator car 1 and the roping tool 13 is mounted preferably as high as possible, in this case just under the roof of the elevator shaft. The roping tool 13 is then suspended from an auxiliary hoist 11 that is hung, for instance, from a solid point 11c in the machine room. After that the hoisting ropes 3 are fastened firmly into the roping tool 13 just under the roof of the elevator shaft. If the mass of the whole bundle of hoisting ropes 3 exceeds the lifting capacity of the auxiliary hoist 11 the bundles to be lowered at the same time must be made smaller, and the lowering step must be done repeatedly more than once.

After the hoisting ropes 3 are fastened into the roping tool 13 just below the roof of the elevator shaft the roping tool is slightly lifted with the auxiliary hoist 11 to get somewhat loose to the hoisting ropes 3 above the roping tool 13. Now the next step is to cut the fastened hoisting ropes 3 just above the roping tool 13 and unfasten the first ends of the hoisting ropes 3 from their fixing points in the elevator car 1. The cut pieces of the hoisting ropes 3 between the elevator car 1 and the roping tool 13 are moved away, for instance, pulled into the machine room above.

Now the next step is to lower the rope bundle of hoisting ropes 3 down together with the roping tool 13. At the same time the lower ends of the hoisting ropes 3 are guided to the rope reels 15 on the lowermost landing floor 7b and the hoisting ropes 3 are wound to the rope reels 15 simultaneously when lowering them down. Finally the rope reels 15 with dismantled hoisting ropes 3 are removed from the lowermost landing floor 7b.

At this stage the elevator car 1 is locked in its position at the top part of the elevator shaft and the counterweight 2 is at the lower part of the elevator shaft supported by the support elements 14, and the elevator has neither hoisting ropes 3 nor compensating ropes 4. In addition the elevator car 1 and the counterweight 2 are supported by their guide rails 16 and 16a.

Now the installation of new hoisting elements and compensating elements can be initialized. When using ultra light hoisting elements, such as flat belts comprising a carbon fiber core and a unique high-friction coating, the first step is to position the elevator car 1 on a correct level for the new hoisting elements, and park it again with safety gears and safety chains. After that the old compensating mechanism 8 is replaced by a new compensating mechanism that is aligned according to the new layouts, and also old lifting arrangements are removed from the elevator shaft.

For modernization also some modifications are done in the machine room. One possibility is to replace the old machinery, traction sheave 5 and bedplate with the new ones. If the old machinery is intended to be used, only the traction sheave 5 and possibly some other replacement parts must be changed and the bedplate must be either modified or changed and aligned according to new layouts.

Finally the fastening points of the hoisting ropes and compensating ropes in the car or car sling and in the counterweight are modified or replaced with new parts that are suitable for new type of hoisting and/or compensating elements.

FIG. 10 presents the situation where the elevator is ready for new roping with all old and unsuitable components removed or modified. After that the new type of the hoisting and/or compensating elements with their machineries and accessories can be installed in a known way.

It is obvious to the person skilled in the art that the invention is not restricted to the examples described above but that it may be varied within the scope of the claims presented below. Thus, for instance the order of the method steps may differ from the order presented in the claims, or method steps may be less than presented in the claims.

1. Method for handling ropes in an elevator, which elevator comprises at least an elevator car arranged to run in an elevator shaft along the guide rails, a counterweight connected to the elevator car with hoisting ropes from above, a hoisting machinery with a traction sheave for driving the elevator car via hoisting ropes, and compensating ropes connected between the elevator car and the counterweight from below, wherein the method comprises at least following steps:
when the elevator car is at a lower part of the elevator shaft the first ends of the compensating ropes are disconnected from their original connection with the elevator car
first ends of the compensating ropes are suspended from the elevator car using an auxiliary hoist carried by the elevator car
the elevator car is run upwards to the upper part of the elevator shaft together with the disconnected first ends of the compensating ropes
the elevator car is attached to the upper part of the elevator shaft and the descended counterweight is supported and/or locked into its position at a lower part of the elevator shaft
the first ends of the compensating ropes are lowered down using the auxiliary hoist.

2. Method for handling ropes in an elevator according to claim 1, wherein the method comprises further the following steps:
the second ends of the compensating ropes are disconnected from the counterweight and routed out of the elevator shaft, and during lowering the first ends of the compensating ropes down using the auxiliary hoist the descending compensating ropes are led out from the elevator shaft.

3. Method for handling ropes in an elevator according to claim 1, wherein the method comprises at least the following steps:
the elevator car is run down to a lower part of the elevator shaft
the compensating ropes are slackened by reducing tension in the compensating mechanism
the first ends of the compensating ropes are unfastened from their fastening points in connection with the elevator car
a roping tool is placed below the elevator car and the unfastened first ends of the compensating ropes are firmly fastened to the roping tool
an auxiliary hoist is installed between the elevator car and the roping tool to hang from the elevator car and to suspend the roping tool
the elevator car is run upwards to the upper part of the elevator shaft together with the auxiliary hoist, the roping tool and the first ends of the compensating ropes
the counterweight is supported and/or locked into its position at a lower part of the elevator shaft
the second ends of the compensating ropes are released from the counterweight and routed out of the elevator shaft, for instance, to empty rope reels on the lowermost landing floor
the roping tool together with the first ends of the compensating ropes is lowered down with the auxiliary hoist and simultaneously the descending compensating ropes are led out from the elevator shaft, for instance, they are wound to rope reels on the lowermost landing floor.

4. Method for handling ropes in an elevator according to claim 1, wherein the roping tool is mounted on the elevator car guide rails below the elevator car.

5. Method for handling ropes in an elevator according to claim 1, wherein when slackening the compensating ropes before unfastening the first ends of the compensating ropes the reduction of tension in the compensating mechanism is done by lifting the deflection sheave arrangement of the compensating mechanism upwards and locking the deflection sheave arrangement in its higher position.

6. Method for handling ropes in an elevator according to claim 1, wherein the elevator car is run upwards to the upper part of the elevator shaft, together with the auxiliary hoist, the roping tool and the first ends of the compensating ropes, using a service run or other slow motion safety run by the help of the control panel of the elevator.

7. Method for handling ropes in an elevator according to claim 1, wherein before lowering the roping tool with the first ends of the compensating ropes empty rope reels are installed on the lowermost landing floor outside the elevator shaft.

8. Method for handling ropes in an elevator according to claim 1, wherein before lowering the roping tool with the first ends of the compensating ropes the elevator car is parked in its position in the upper part of the elevator shaft, for instance, with the help of the safety gears of the elevator, or separate clamps on the guide rails or with separate safety chains.

9. Method for modernizing ropes in an elevator, which elevator comprises at least an elevator car arranged to run in an elevator shaft along the guide rails, a counterweight connected to the elevator car with hoisting ropes from above, a hoisting machinery with a traction sheave above the elevator car, and compensating ropes connected between the elevator car and the counterweight through a compensating mechanism at a lower part of the elevator shaft, wherein the method for modernizing ropes in an elevator comprises at least following steps:
a) Dismantling of the old compensating ropes comprising:
when the elevator car is at a lower part of the elevator shaft the first ends of the compensating ropes are disconnected from their original connection with the elevator car
first ends of the compensating ropes are suspended from the elevator car using an auxiliary hoist carried by the elevator car
the elevator car is run upwards to the upper part of the elevator shaft together with the disconnected first ends of the compensating ropes
the elevator car is attached to the upper part of the elevator shaft and the descended counterweight is supported and/or locked into its position at a lower part of the elevator shaft
the first ends of the compensating ropes are lowered down using the auxiliary hoist.
b) Dismantling of the old hoisting ropes is done after the dismantling of the old compensating ropes has been completed, and the elevator car is parked and locked in its position in the upper part of the elevator shaft, and the counterweight is supported by the support element in the lower part of the elevator shaft, the dismantling of the old hoisting ropes comprising:
the second ends of the hoisting ropes are disconnected from the counterweight
at the upper part of the elevator shaft the hoisting ropes are suspended from an auxiliary hoist, and thereafter the hoisting ropes are cut just above their suspension points, and the first ends of the hoisting ropes are disconnected from their fixing points in connection with the elevator car
the cut ends of the hoisting ropes are lowered down with the auxiliary hoist.
c) Before installing new hoisting and compensating ropes or elements the layouts and components in the elevator shaft and machine room are modified to be suitable for the new hoisting and compensating ropes or elements.
d) After the steps a), b) and c) above new hoisting and compensating ropes or elements are installed.

10. Method for modernizing ropes in an elevator according to claim 9, wherein the method for modernizing ropes in an elevator comprises further following steps:
before lowering the first ends of the compensation ropes using the auxiliary hoist in the dismantling phase the second ends of the compensating ropes are disconnected from the counterweight and routed out of the elevator shaft, and during lowering the first ends of the compensating ropes down using the auxiliary hoist the descending compensating ropes are led out from the elevator shaft
during lowering the cut ends of the hoisting ropes down using the auxiliary hoist the descending hoisting ropes are led out from the elevator shaft.

11. Method for modernizing ropes in an elevator according to claim 9, wherein the method for modernizing ropes in an elevator comprises at least following steps:
e) Dismantling of the old compensating ropes comprising:
the elevator car is run down to a lower part of the elevator shaft
the compensating ropes are slackened by reducing tension in the compensating mechanism
the first ends of the compensating ropes are disconnected from their fastening points in connection with the elevator car
a roping tool is placed below the elevator car and the unfastened first ends of the compensating ropes are firmly fastened to the roping tool
an auxiliary hoist is installed between the elevator car and the roping tool to hang from the elevator car and to suspend the roping tool
the elevator car is run upwards to the upper part of the elevator shaft together with the auxiliary hoist, the roping tool and the first ends of the compensating ropes
the counterweight is supported into its position at a lower part of the elevator shaft
the second ends of the compensating ropes are released from the counterweight and routed out of the elevator shaft, for instance, to empty rope reels on the lowermost landing floor
the roping tool together with the first ends of the compensating ropes is lowered down with the auxiliary hoist and simultaneously the descending compensating ropes are led out from the elevator shaft, for instance, they are wound to rope reels on the lowermost landing floor.
f) Dismantling of the old hoisting ropes is done after the dismantling of the old compensating ropes has been completed, and the elevator car is parked and locked in its position in the upper part of the elevator shaft, and the counterweight is supported by the support element in the lower part of the elevator shaft, the dismantling of the old hoisting ropes comprising:
the second ends of the hoisting ropes are unfastened from the counterweight
working on the roof of the elevator car a roping tool is placed in its position at the upper part of the elevator shaft
an auxiliary hoist is installed to hang in a machine room and to suspend the roping tool
the hoisting ropes at the upper part of the elevator shaft are fastened firmly into the roping tool
the hoisting ropes are cut just above the roping tool and the first ends of the hoisting ropes are unfastened from their fixing points in connection with the elevator car
the roping tool together with the cut ends of the hoisting ropes is lowered down with the auxiliary hoist and simultaneously the descending hoisting ropes are led out from the elevator shaft.
g) Before installing new hoisting and compensating ropes or elements the layouts and components in the elevator shaft and machine room are modified to be suitable for the new hoisting and compensating ropes or elements.
h) After the steps a), b) and c) new hoisting and compensating ropes or elements are installed.

12. Method for modernizing ropes in an elevator according to claim 9, wherein the roping tool is mounted on the counterweight guide rails as high as possible in the elevator shaft.

13. Method for modernizing ropes in an elevator according to claim 9, wherein before lowering the roping tool together with the cut ends of the hoisting ropes empty rope reels are arranged on the lowermost landing floor.

14. Method for modernizing ropes in an elevator according to claim 9, wherein when lowering the roping tool together with the cut ends of the hoisting ropes the descending parts of the hoisting ropes are simultaneously led out from the elevator shaft, for instance, they are wound to rope reels on the lowermost landing floor.

15. Method for modernizing ropes in an elevator according to claim 9, wherein the old hoisting and compensating ropes are replaced with new ropes and/or elements that are lighter than the old ones.

16. Method for modernizing ropes in an elevator according to claim 9, wherein the new ropes and/or elements are substantially flat belts comprising a carbon fiber core and a high-friction coating.

17. Arrangement for dismantling compensating ropes and/or hoisting ropes of an elevator, which elevator comprises at least an elevator car arranged to run in an elevator shaft along the guide rails, a counterweight connected to the elevator car with hoisting ropes from above, a hoisting machinery with a traction sheave above the elevator car, and compensating ropes connected between the elevator car and the counterweight through a compensating mechanism at a lower part of the elevator shaft, wherein arrangement comprises a roping tool for fastening the unfastened ends of the compensating ropes and/or hoisting ropes, and an auxiliary hoist for lowering the roping tool with the ends of the compensating ropes and/or hoisting ropes from the upper part of the elevator shaft to the lower part of the elevator shaft.

18. Arrangement according to claim 17, wherein the roping tool comprises a frame for fastening the unfastened or cut rope ends together as one bundle and a suspension hook for suspending the roping tool together with the rope ends from the auxiliary hoist.

19. Arrangement according to claim 17, wherein the roping tool comprises slide blocks for mounting the roping tool to move on the elevator car guide rails and/or counterweight guide rails.
